(19) United States
(12) Patent Application Publication
(10) Pub. No.: US 2025/0272396 A1
(43) Pub. Date: Aug. 28, 2025

(54) PLACEMENT LOCATION SELECTION DEVICE, PLACEMENT LOCATION SELECTION METHOD, AND NON-TRANSITORY COMPUTER READABLE MEDIUM

(71) Applicant: Mitsubishi Electric Corporation, Tokyo (JP)

(72) Inventors: Takumi YAMAMOTO, Tokyo (JP); Aiko IWASAKI, Tokyo (JP)

(73) Assignee: Mitsubishi Electric Corporation, Tokyo (JP)

(21) Appl. No.: 19/179,813

(22) Filed: Apr. 15, 2025

Related U.S. Application Data
(63) Continuation of application No. PCT/JP2022/044979, filed on Dec. 6, 2022.

(51) Int. Cl. G06F 21/56; G06F 16/185

(52) U.S. Cl. CPC G06F 21/562; G06F 16/185

(57) ABSTRACT

A placement location selection device (100) includes a web bug embedding unit (130) and a beacon monitoring unit (140). The web bug embedding unit (130) embeds a notification function in a target file that exists in a placement target area. The notification function is a function to transmit notification data to outside of a system where the target file is stored when the target file is opened outside the target system. The placement target area is an area corresponding to part of a file tree managed by the target system and including a file estimated not to be used by a high-risk user who is a user of the target system in normal work of the high-risk user among one or more files accessed by the high-risk user. The beacon monitoring unit (140) monitors whether the notification data has been transmitted.

### CROSS REFERENCE TO RELATED APPLICATION

This application is a Continuation of PCT International Application No. PCT/JP2022/044979, filed on Dec. 6, 2022, which is hereby expressly incorporated by reference into the present application.

### TECHNICAL FIELD

The present disclosure relates to a placement location selection device, a placement location selection method, and a placement location selection program.

### BACKGROUND ART

As a countermeasure against security attacks, there is a deception system that uses decoy data. Patent Literature 1 discloses a technology that intercepts a data read from a process determined to be fraudulent and returns false data to the process.

### CITATION LIST

### Patent Literature

Patent Literature 1: US 977,310,9 B2

### SUMMARY OF INVENTION

### Technical Problem

The technology disclosed in Patent Literature 1 may return false data to a legitimate process because the accuracy of fraud assessment is not necessarily perfect. If false data is returned to a legitimate process, the work of a legitimate user without malicious intent will be hindered. Therefore, a problem of this technology is that there is a risk of interfering with the work of a legitimate user without malicious intent.

An object of the present disclosure is to reduce a risk of interfering with the work of a legitimate user without malicious intent in a deception system that uses decoy data.

### Solution to Problem

A placement location selection device according to the present disclosure includes
a web bug embedding unit to embed a notification function in a target file that is present in a placement target area, the notification function being a function to transmit notification data to outside of a system where the target file is stored when the target file is opened outside a target system, the placement target area being an area corresponding to part of a file tree managed by the target system and including a file estimated not to be used by a high-risk user who is a user of the target system in normal work of the high-risk user among one or more files accessed by the high-risk user; and
a beacon monitoring unit to monitor whether the notification data has been transmitted,
wherein the file tree is a file system that hierarchically manages a plurality of files.

### Advantageous Effects of Invention

According to the present disclosure, a notification function is embedded in a file estimated not to be used in normal work of a high-risk user, so that a risk of interfering with the work of a legitimate user without malicious intent due to a file access by the high-risk user is relatively low. Additionally, the content of a file in which a notification function is embedded is not altered by embedding the notification function, so that a risk of interfering with the work of a legitimate user is relatively low even if the legitimate user without malicious intent uses the file in which the notification function is embedded.

Therefore, according to the present disclosure, it is possible to reduce a risk of interfering with the work of a legitimate user without malicious intent in a deception system that uses decoy data.

### BRIEF DESCRIPTION OF DRAWINGS

FIG. 1 is a figure illustrating a configuration example of a placement location selection device 100 according to Embodiment 1;

FIG. 2 is a figure illustrating an implementation example of a placement location selection system 90 according to Embodiment 1;

FIG. 3 is a figure illustrating a hardware configuration example of the placement location selection device 100 according to Embodiment 1;

FIG. 4 is a flowchart illustrating the operation of the placement location selection device 100 according to Embodiment 1;

FIG. 5 is a figure illustrating a hardware configuration example of the placement location selection device 100 according to a variation of Embodiment 1;

FIG. 6 is a figure illustrating a configuration example of the placement location selection device 100 according to Embodiment 2; and

FIG. 7 is a flowchart illustrating the operation of the placement location selection device 100 according to Embodiment 2.

### DESCRIPTION OF EMBODIMENTS

In the description and drawings of embodiments, the same reference numerals are assigned to the same elements and corresponding elements. The description of elements with the same reference numerals is omitted or simplified as appropriate. Arrows in figures mainly indicate flows of data or flows of processing. “Unit” may be interpreted as “circuit,” “step”, “procedure”, “process”, or “circuitry” as appropriate.

### Embodiment 1

This embodiment will be described in detail below with reference to the drawings.

### ***Description of Configuration***

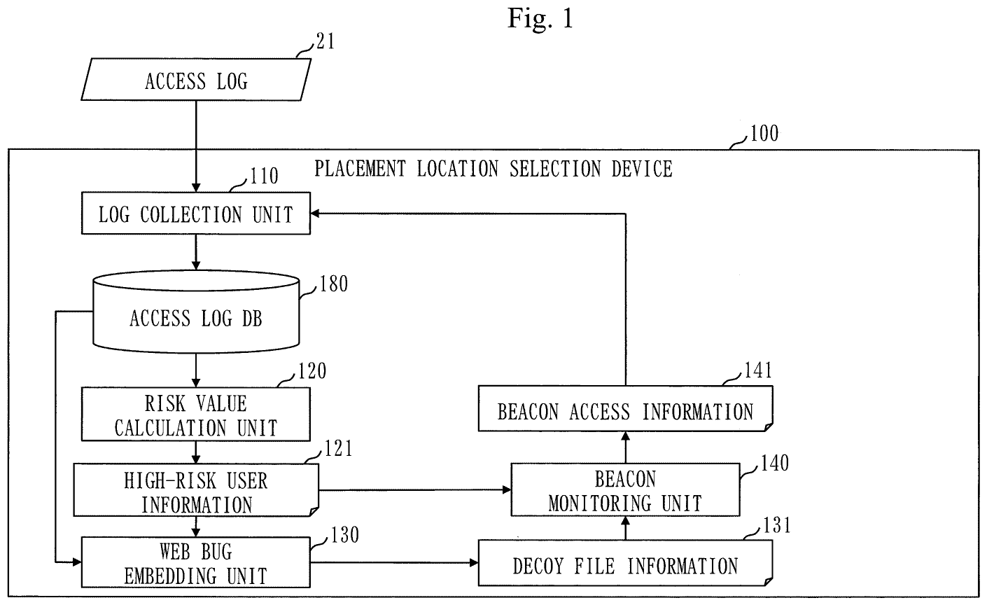

FIG. 1 illustrates a configuration example of a placement location selection device 100 according to this embodiment. As indicated in FIG. 1, the placement location selection device 100 includes a log collection unit 110, a risk value calculation unit 120, a web bug embedding unit 130, and a beacon monitoring unit 140. The placement location selection device 100 also stores an access log database (DB) 180.

The log collection unit 110 collects an access log 21 and monitoring results from the beacon monitoring unit 140, and records the collected data in the access log DB 180. The access log 21 is a file access log in a target system 20.

The target system 20 is a computer system that is used by a plurality of users during work and stores a plurality of files. The target system 20 is, as a specific example, a system operated based on zero trust and is composed of at least one of an on-premises system and a cloud system. The target system 20 manages each file of the plurality of files as part of a file tree. The file tree is a file system that hierarchically manages the plurality of files. In the target system 20, each file is stored in a folder, and each user accesses each file managed by the target system 20 using a file access tool. A folder is also called a directory. The file access tool is a tool for each user to access each file and is an explorer and a browser, as a specific example.

The risk value calculation unit 120 calculates a risk value corresponding to each user based on a file access log or the like in the target system 20. When a decoy file 191 is not placed, the risk value calculation unit 120 typically calculates a risk value corresponding to each user based on the access pattern of each user in the target system 20. Also when the decoy file 191 is placed, the risk value calculation unit 120 may calculate a risk value corresponding to each user based on the access pattern of each user in the target system 20. When the decoy file 191 is placed in the target system 20, the risk value calculation unit 120 may use beacon access information 141 when calculating a risk value corresponding to each user. The risk value calculation unit 120 may raise a risk value corresponding to a target user when notification data is transmitted from outside the target system 20, that is, when the target user has accessed at least one of one or more decoy files 191 stored outside the target system 20 or outside a target organization. The target user is typically a high-risk user. Each user is a user of the target system 20. Each user may be a human or a computer.

The risk value corresponding to each user is a value calculated according to the behavior of each user in the target system 20 and corresponds to a possibility that each user is actually a malicious insider. The behavior of each user in the target system 20 is the conduct of each user in the target system 20. Components of the behavior of each user are, as a specific example, files accessed by each user, an order in which each user has accessed the files, a time period during which each user has accessed the files, the number of files accessed by each user per unit time, and take-out of data to the outside of the target organization by each user. A malicious insider is an entity that operates within an organization with the intent to steal data from the organization. As a specific example, a malicious insider is an internal attacker in the target system 20 or malware that has stolen legitimate credentials and is infecting a personal computer (PC) used in the organization managing the target system 20. An internal attacker is a user who engages in a security attack within the organization among users with legitimate access privileges. An internal attacker is also a user with malicious intent. As a specific example, malware is one that operates autonomously on its own, or one that operates according to commands from an attacker outside the organization via a command & control server on the Internet.

The risk value calculation unit 120 may model a pattern of normal behavior in the target system 20 for each user in advance based on the file access log or the like, and calculate a degree of deviation of the actual behavior of each user in the target system 20 from the modeled pattern of normal behavior as the risk value corresponding to each user. When modeling the pattern of normal behavior, the risk value calculation unit 120 may utilize technologies such as machine learning, and may use technologies that detect anomalies in behavior for each user based on an access log, such as user and entity behavior analytics (UEBA).

Additionally, the risk value calculation unit 120 generates high-risk user information 121 and outputs the generated high-risk user information 121. The high-risk user information 121 is information indicating each high-risk user and the characteristics of each high-risk user. As a specific example, the high-risk user information 121 includes data indicating each high-risk user, a risk value corresponding to each high-risk user, one or more files accessed by each high-risk user, and so on. A high-risk user is a user of the target system 20, and is a user whose corresponding risk value is equal to or greater than a risk reference value, which is a predetermined threshold, and who has a relatively high possibility of being a malicious insider among the users of the target system 20. When at least one of the access log 21 and the beacon access information 141 is updated, the high-risk user information 121 may also be updated based on the updated information.

The web bug embedding unit 130 embeds a notification function in a target file present in a placement target area. The placement target area is an area corresponding to part of the file tree managed by the target system 20 and including a file estimated not to be used by a high-risk user in normal work of the high-risk user among one or more files accessed by the high-risk user. The notification function is a function to transmit notification data to the outside of a system where the target file is stored when the target file is opened outside the target system 20. As a specific example, the notification function is realized by a web bug. The notification data corresponding to the target file includes information indicating the target file and the user who has opened the target file. Embedding the notification function in the target file includes embedding the notification function in a file generated by copying the target file.

Specifically, the web bug embedding unit 130 refers to the high-risk user information 121 and the access log DB 180, selects some files around a file accessed by each high-risk user with relatively low frequency among files accessed by each high-risk user indicated by the high-risk user information 121, and embeds a web bug in each selected file. Each selected file is, as a specific example, a Microsoft Office (registered trademark) document or a Portable Document Format (PDF) file. It is assumed that a web bug includes information that can identify the file in which the web bug is embedded and the user who has opened the file in which the web bug is embedded. The web bug embedding unit 130 may identify a normal access area corresponding to each high-risk user indicated by the high-risk user information 121, and embed a web bug in a file present in an area that is other than the identified normal access area and includes a file accessed by each high-risk user. The normal access area corresponding to each user is an area that is accessed by each user in normal work of each user, is accessed by each user with relatively high frequency, and as a specific example, is composed of one or more files and one or more directories normally accessed by each user. In this case, as a specific example, the web bug embedding unit 130 treats a file and a directory accessed by each user a predetermined number of times or more within a predetermined period as a file and a directory usually accessed by each user. Normal work can be defined in any way. Among the areas accessed by each high-risk user, an area other than the normal access area corresponding to each high-risk user is equivalent to the placement target area.

As a specific example, the web bug embedding unit 130 appends decoy file information 131 to the uniform resource locator (URL) of the web bug. The decoy file information 131 is information including information that can identify the decoy file 191 and the user who has opened the decoy file 191. The web bug embedding unit 130 may encrypt the decoy file information 131 when embedding the decoy file information 131 in the beacon. In this case, as a specific example, the web bug embedding unit 130 uses an encryption key shared by the web bug embedding unit 130 and the beacon monitoring unit 140.

The functions of the web bug embedding unit 130 are realized by a plug-in of a file access tool, as a specific example. The plug-in is a software module that realizes additional functions for the file access tool. The file access tool is a tool for each user to access each file and is, as a specific example, an explorer or a browser. The web bug embedding unit 130 may instruct the plug-in to embed a web bug in a file, and may embed a web bug in a file generated by copying when a file managed by the target system 20 is copied.

A method for embedding a web bug is, as a specific example, a method of inserting, in a document, an image that is resized to a minute size and is displayed by referencing a resource stored on an external server. A specific example of a web bug is described in Reference 1.

[Reference 1]“Bugging Microsoft Files: Part 1—Docx Files Using Microsoft Word”, BLACK HILLS INFORMATION SECURITY, [Online], [Accessed Nov. 4, 2022], Internet <https://www.blackhillsinfosec.com/bugging-docx-files-using-microsoft-word-part-1/>

The beacon monitoring unit 140 monitors whether notification data has been transmitted from the decoy file 191. The beacon monitoring unit 140 may be an external server that stores the resource referenced by the web bug, and may also have a function of receiving data indicating monitoring results from an external server that monitors data transmitted from the decoy file 191. Monitoring whether notification data has been transmitted involves, as specific examples, checking whether the placement location selection device 100 has received notification data, or checking whether the placement location selection device 100 has received data indicating that an external server has received notification data.

If the decoy file 191 is opened outside the target system 20, that is, if information leakage occurs in the target system 20, beacon communication to the beacon monitoring unit 140 occurs. Even if the decoy file 191 is opened within the target system 20, beacon communication to the beacon monitoring unit 140 may occur. If the beacon communication is from within a target organization, the beacon monitoring unit 140 remains passive. The target organization is the organization that manages the target system 20. If the beacon communication is from outside the target organization, the beacon monitoring unit 140 compares the decoy file information 131 embedded in the data corresponding to the beacon communication with the decoy file information 131 managed by the beacon monitoring unit 140. The data corresponding to the beacon communication is a specific example of notification data. In this case, the beacon monitoring unit 140 extracts the decoy file information 131 from the beacon communication that has accessed the beacon monitoring unit 140, identifies the decoy file 191 and the user who has opened the decoy file 191 based on the extracted decoy file information 131, generates beacon access information 141 based on the result of identification, and issues the generated beacon access information 141. The beacon access information 141 is, as a specific example, information indicating each decoy file 191 that has executed beacon communication and the user who has opened each decoy file 191.

If the decoy file information 131 is encrypted, the beacon monitoring unit 140 decrypts the decoy file information 131 using an encryption key shared by the web bug embedding unit 130 and the beacon monitoring unit 140, as a specific example.

An analyst may narrow down high-risk users based on the beacon access information 141 and the high-risk user information 121, and may reflect the result of narrowing down in the high-risk user information 121. The analyst is, for example, a person or computer that analyzes security attacks on the target system 20.

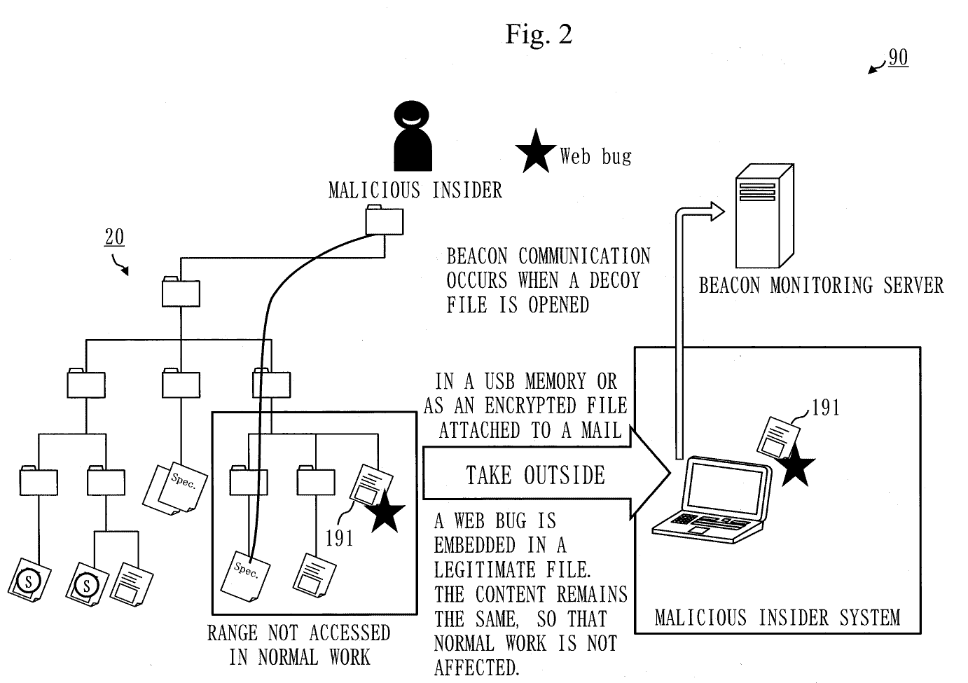

FIG. 2 illustrates an implementation example of a placement location selection system 90. It is considered acceptable to process a legitimate file itself within a range that does not affect the normal work of each user. A legitimate file is a file legitimately managed in the target system 20. Therefore, the web bug embedding unit 130 generates the decoy file 191 by embedding a web bug in a legitimate file itself that is present around a file accessed by a high-risk user and different from files usually accessed by the high-risk user. Since the content of the file remains the same before and after embedding the web bug, it is considered that embedding the web bug does not basically affect the normal work of each user.

As a specific example, a malicious insider takes the decoy file 191 outside the target system 20 by copying the decoy file 191 to a Universal Serial Bus (USB) memory or by sending an email with the encrypted decoy file 191 attached. Then, the malicious insider opens the decoy file 191 in a malicious insider system. The malicious insider system is a computer system not managed by the target organization, and is a computer, server, or the like used by the malicious insider. When the decoy file 191 is opened, beacon communication to a beacon monitoring server occurs.

The beacon monitoring server detects the opening of the decoy file 191 on the malicious insider system by receiving the beacon communication from the malicious insider system.

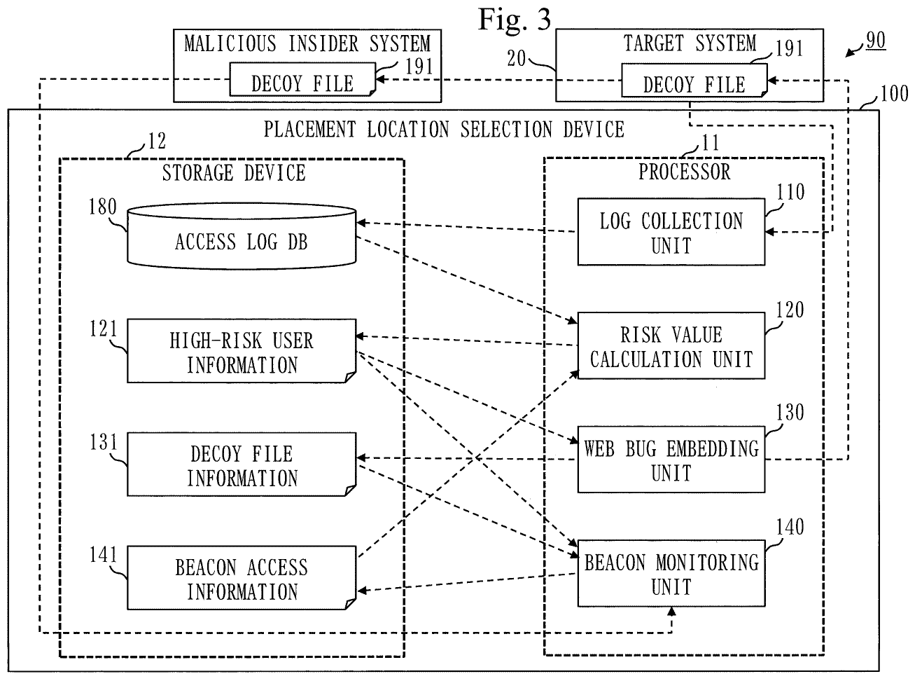

FIG. 3 illustrates a hardware configuration example of the placement location selection device 100 according to this embodiment. The placement location selection device 100 is composed of a general computer. The placement location selection device 100 may be composed of a plurality of computers. The target system 20 and the placement location selection device 100 may be configured integrally.

As illustrated in this figure, the placement location selection device 100 is a computer that includes hardware such as a processor 11 and a storage device 12. These hardware components are appropriately connected via signal lines.

The processor 11 is an integrated circuit (IC) that performs operational processing and controls the hardware included in the computer. The processor 11 is, as a specific example, a central processing unit (CPU), a digital signal processor (DSP), or a graphics processing unit (GPU).

The placement location selection device 100 may include a plurality of processors as an alternative to the processor 11. The plurality of processors share the role of the processor 11.

The storage device 12 is composed of at least one of a volatile storage device and a non-volatile storage device. The volatile storage device is, as a specific example, a random access memory (RAM). The non-volatile storage device is, as a specific example, a read only memory (ROM), a hard disk drive (HDD), or a flash memory. Data stored in the storage device 12 is loaded into the processor 11 as needed.

The placement location selection device 100 may include hardware such as an input/output interface (IF) and a communication device.

The input/output IF is a port to which an input device and an output device are connected. The input/output IF is, as a specific example, a USB terminal. The input device is, as a specific example, a keyboard and a mouse. The output device is, as a specific example, a display.

The communication device is a receiver and a transmitter. The communication device is, as a specific example, a communication chip or a network interface card (NIC).

Each unit of the placement location selection device 100 may appropriately use the input/output IF and the communication device when communicating with other devices.

The storage device 12 stores a placement location selection program. The placement location selection program is a program that causes a computer to realize the functions of each unit included in the placement location selection device 100. The placement location selection program is loaded into the storage device 12 and executed by the processor 11. The functions of each unit included in the placement location selection device 100 are realized by software.

The storage device 12 may store files managed by the target system 20.

Data used when the placement location selection program is executed and data obtained by executing the placement location selection program are appropriately stored in the storage device 12. Each unit of the placement location selection device 100 appropriately utilizes the storage device 12. The term data and the term information may have equivalent meanings.

The storage device 12 may be independent of the computer. Each database may be stored on an external server or the like.

The placement location selection program may be recorded on a computer readable non-volatile recording medium. The non-volatile recording medium is, as a specific example, an optical disc or a flash memory. The placement location selection program may be provided as a program product.

### ***Description of Operation***

A procedure for the operation of the placement location selection device 100 is equivalent to a placement location selection method. A program that realizes the operation of the placement location selection device 100 is equivalent to the placement location selection program.

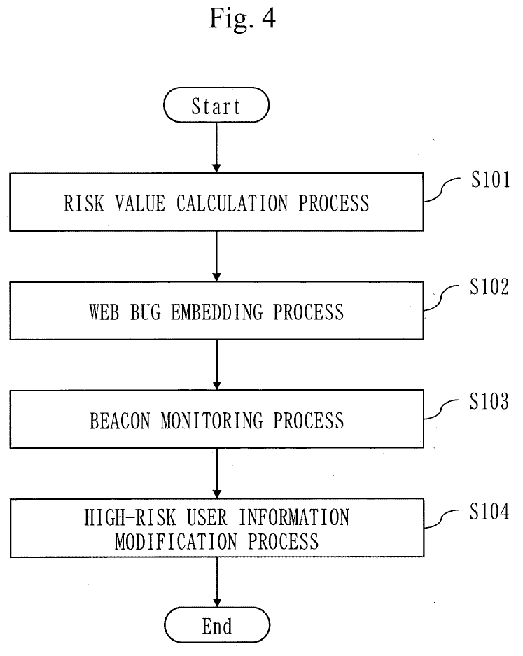

FIG. 4 is a flowchart illustrating an example of the operation of the placement location selection device 100. Referring to FIG. 4, the operation of the placement location selection device 100 will be described.

### (Step S101: Risk Value Calculation Process)

The risk value calculation unit 120 refers to the access log DB 180, and calculates a risk value related to the behavior of each user as a risk value corresponding to each user based on a file access log.

### (Step S102: Web Bug Embedding Process)

The web bug embedding unit 130 embeds a web bug corresponding to each file in each file stored in each folder not usually used by a high-risk user among folders accessed by the high-risk user, and treats each file in which the web bug is embedded as the decoy file 191.

### (Step S103: Beacon Monitoring Process)

The beacon monitoring unit 140 monitors beacon communication, generates beacon access information 141 based on the result of monitoring when beacon communication from the decoy file 191 has occurred, and outputs the beacon access information 141 that has been generated.

### (Step S104: High-Risk User Information Modification Process)

The risk value calculation unit 120 modifies the high-risk user information 121 based on the beacon access information 141 that has been output.

### ***Description of Effects of Embodiment 1***

As described above, according to this embodiment, the decoy file 191 is generated by embedding a web bug in a file. Even if the web bug is embedded in the file, the content of the file is not changed. Therefore, according to this embodiment, it is possible to reduce a possibility of the work of a legitimate user being hindered even if the legitimate user accesses the decoy file 191.

Additionally, according to this embodiment, since the decoy file 191 is placed avoiding areas usually accessed by high-risk users, unnecessary beacon communication can be reduced.

### ***Other Configurations***

### <Variation 1>

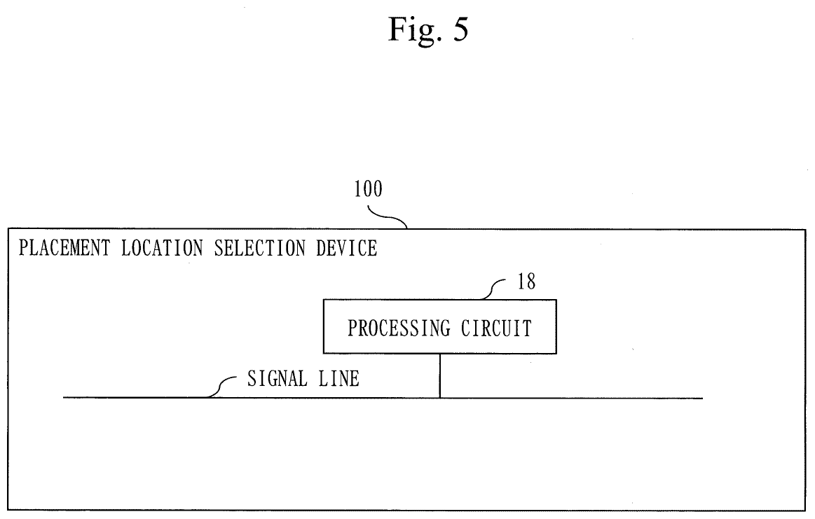

FIG. 5 illustrates a hardware configuration example of the placement location selection device 100 according to this variation.

The placement location selection device 100 includes a processing circuit 18 in place of the processor 11 or in place of the processor 11 and the storage device 12.

The processing circuit 18 is hardware that realizes at least part of the units included in the placement location selection device 100.

The processing circuit 18 may be dedicated hardware, or may be a processor that executes programs stored in the storage device 12.

When the processing circuit 18 is dedicated hardware, the processing circuit 18 is, as a specific example, a single circuit, a composite circuit, a programmed processor, a parallel-programmed processor, an application specific integrated circuit (ASIC), a field programmable gate array (FPGA), or a combination of these.

The placement location selection device 100 may include a plurality of processing circuits as an alternative to the processing circuit 18. The plurality of processing circuits share the role of the processing circuit 18.

In the placement location selection device 100, some functions may be realized by dedicated hardware, and the remaining functions may be realized by software or firmware.

As a specific example, the processing circuit 18 is realized by hardware, software, firmware, or a combination of these. The processor 11, the storage device 12, and the processing circuit 18 are collectively referred to as “processing circuitry”. In other words, the functions of the functional components of the placement location selection device 100 are realized by the processing circuitry.

The placement location selection device 100 according to other embodiments may have substantially the same configuration as that of this variation.

### Embodiment 2

Differences from the embodiment described above will be mainly described below with reference to the drawings.

There are cases where the decoy file 191 is legitimately taken outside the target organization. However, even in a case where the decoy file 191 is legitimately taken outside the target organization, beacon communication from outside the target organization occurs, so that there is a risk of false detection regarding taking the decoy file 191 outside in Embodiment 1.

On the other hand, many organizations have introduced a workflow system that has a function to manage taking confidential information outside legitimately.

Therefore, an object of this embodiment is to reduce a risk of false detection regarding taking the decoy file 191 outside by comparing information registered in a workflow system with the decoy file information 131 embedded in data corresponding to beacon communication from the decoy file 191.

### ***Description of Configuration***

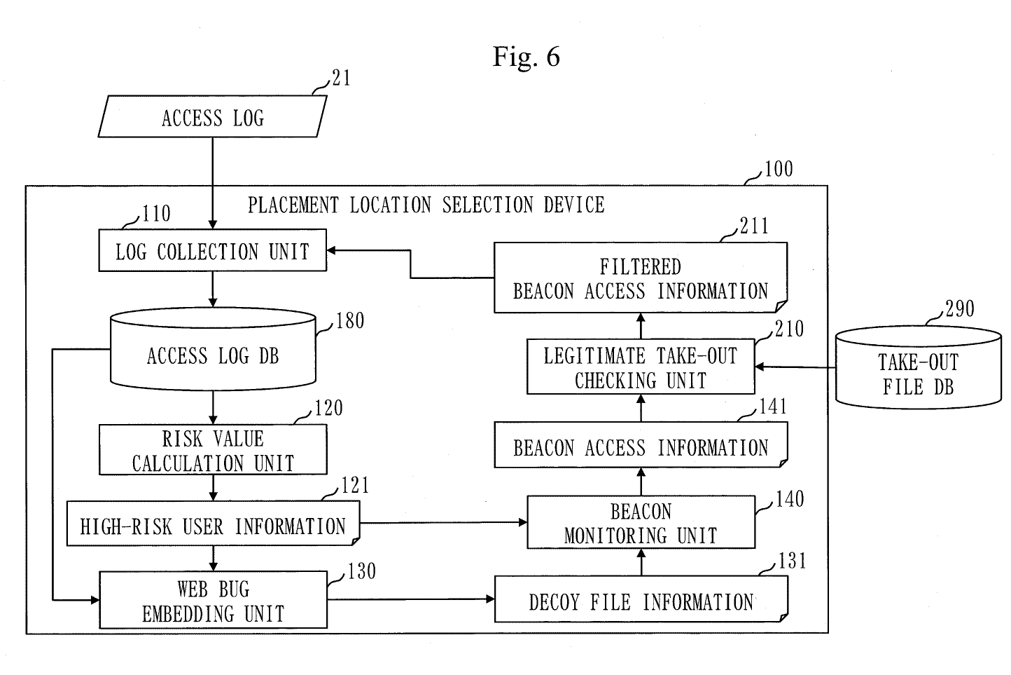

FIG. 6 illustrates a configuration example of the placement location selection device 100 according to this embodiment. The placement location selection device 100 further includes a legitimate take-out checking unit 210, as indicated in FIG. 6. The placement location selection device 100 accesses a take-out file DB 290. The placement location selection device 100 and the take-out file DB 290 may be integrally configured.

In the take-out file DB 290, each file that is legitimately taken outside the target system 20 is registered. As a specific example, the take-out file DB 290 stores information indicating users who legitimately take files outside the target organization and each file that each user legitimately takes outside the target system 20. The take-out file DB 290 may be communicably connected with the beacon monitoring server.

As a specific example, the take-out file DB 290 is part of the workflow system. The workflow system is assumed to have a function to process a take-out permission procedure. Through the take-out permission procedure using the workflow system, information indicating files legitimately taken outside the target organization and the users who legitimately take the files outside the target organization is registered in the take-out file DB 290. A specific example of the workflow system is indicated in [Reference 2].

[Reference 2]“Hibun AE ContentsGate”, Hitachi Solutions, Ltd., [Online], [Accessed Nov. 4, 2022], Internet <URL: https://www.hitachi-solutions.co.jp/hibun/sp/product/ae cog.html>

When notification data is transmitted from outside the target system 20, the legitimate take-out checking unit 210 checks whether a target file corresponding to the transmitted notification data is registered in the take-out file DB 290.

As a specific example, if the recent information registered in the take-out file DB 290 does not include the user and the decoy file 191 indicated by the beacon access information 141, the legitimate take-out checking unit 210 issues the beacon access information 141 indicating that the decoy file 191 indicated by the beacon access information 141 has not been taken outside legitimately. In other cases, the legitimate take-out checking unit 210 generates filtered beacon access information 211 by deleting information indicating each user and the file corresponding to each user registered in the take-out file DB 290 from the beacon access information 141, and outputs the generated filtered beacon access information 211.

An analyst may narrow down high-risk users based on the filtered beacon access information 211 and the high-risk user information 121.

### ***Description of Operation***

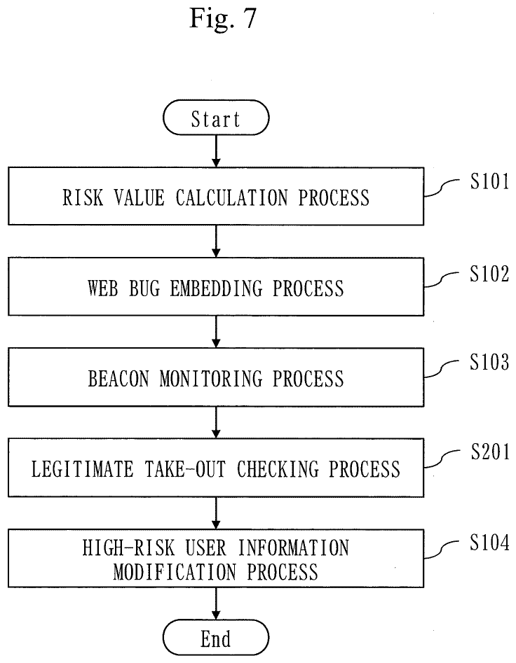

FIG. 7 is a flowchart illustrating an example of the operation of the placement location selection device 100. The operation of the placement location selection device 100 will be described with reference to FIG. 7.

### (Step S201: Legitimate Take-Out Checking Process)

The legitimate take-out checking unit 210 checks the user and file indicated by the beacon access information 141 against the users and files registered in the take-out file DB 290. If the file indicated by the beacon communication is a file legitimately taken outside by the user indicated by the beacon communication, the legitimate take-out checking unit 210 generates filtered beacon access information 211 by deleting the information indicating the user and file indicated by the beacon communication from the beacon access information 141, and outputs the generated filtered beacon access information 211.

If the user and file indicated by the beacon communication are included in the recent take-out file DB 290, the risk value calculation unit 120 may lower the risk value corresponding to the user.

### ***Description of Effects of Embodiment 2***

As described above, according to this embodiment, the legitimate take-out checking unit 210 checks the information indicated by beacon communication against the information registered in the take-out file DB 290, and edits the beacon access information 141 when the decoy file 191 corresponding to the beacon communication is a file legitimately taken outside. Therefore, according to this embodiment, it is possible to reduce a risk of false detection when the decoy file 191 is legitimately taken outside.

### ***Other Embodiments***

The embodiments described above may be freely combined, or any constituent element of each embodiment may be modified, or any constituent element may be omitted in each embodiment.

The embodiments are not limited to those described in Embodiments 1 and 2, and various modifications are possible as necessary. The procedures described using flowcharts or the like may be appropriately modified.

### REFERENCE SIGNS LIST

11: processor; 12: storage device; 18: processing circuit; 20: target system; 21: access log; 90: placement location selection system; 100: placement location selection device; 110: log collection unit; 120: risk value calculation unit; 121: high-risk user information; 130: web bug embedding unit; 131: decoy file information; 140: beacon monitoring unit; 141: beacon access information; 180: access log DB; 191: decoy file; 210: legitimate take-out checking unit; 211: filtered beacon access information; 290: take-out file DB.

1. A placement location selection device comprising
processing circuitry to:
embed a notification function in a target file that is present in a placement target area, the notification function being a function to transmit notification data to outside of a system where the target file is stored when the target file is opened outside a target system, the placement target area being an area corresponding to part of a file tree managed by the target system and including a file estimated not to be used by a high-risk user who is a user of the target system in normal work of the high-risk user among one or more files accessed by the high-risk user; and
monitor whether the notification data has been transmitted,
wherein the file tree is a file system that hierarchically manages a plurality of files.

2. The placement location selection device according to claim 1,
wherein the notification data includes information indicating the target file and a user who has opened the target file.

3. The placement location selection device according to claim 1,
wherein the notification function is realized by a web bug.

4. The placement location selection device according to claim 1,
wherein the processing circuitry calculates a risk value corresponding to each user based on an access pattern in the target system of each user of the target system, and
wherein the high-risk user is a user whose corresponding risk value is equal to or greater than a risk reference value among users of the target system.

5. The placement location selection device according to claim 4,
wherein the processing circuitry raises the risk value corresponding to the high-risk user when the notification data is transmitted from outside the target system.

6. The placement location selection device according to claim 1,
wherein when the notification data is transmitted from outside the target system, the processing circuitry checks whether a target file corresponding to the transmitted notification data is registered in a take-out file database in which each file legitimately taken outside the target system is registered.

7. The placement location selection device according to claim 6,
wherein the take-out file database is part of a workflow system.

8. A placement location selection method comprising:
embedding a notification function in a target file that is present in a placement target area, the notification function being a function to transmit notification data to outside of a system where the target file is stored when the target file is opened outside a target system, the placement target area being an area corresponding to part of a file tree managed by the target system and including a file estimated not to be used by a high-risk user who is a user of the target system in normal work of the high-risk user among one or more files accessed by the high-risk user, by a computer; and
monitoring whether the notification data has been transmitted, by the computer,
wherein the file tree is a file system that hierarchically manages a plurality of files.

9. A non-transitory computer readable medium storing a placement location selection program that causes a placement location selection device, which is a computer, to execute:
a web bug embedding process of embedding a notification function in a target file that is present in a placement target area, the notification function being a function to transmit notification data to outside of a system where the target file is stored when the target file is opened outside a target system, the placement target area being an area corresponding to part of a file tree managed by the target system and including a file estimated not to be used by a high-risk user who is a user of the target system in normal work of the high-risk user among one or more files accessed by the high-risk user; and
a beacon monitoring process of monitoring whether the notification data has been transmitted,
wherein the file tree is a file system that hierarchically manages a plurality of files.
